(19) United States
(12) Patent Application Publication
(10) Pub. No.: US 2010/0293360 A1
(43) Pub. Date: Nov. 18, 2010

(54) AUTOMATION DEVICE WITH CONTROL PROGRAM AND METHOD FOR PROGRAMMING THEREOF

(75) Inventors: Ronald Schoop, Hainburg (DE); Ivan Delamer, Tampere (FI); Armando Walter Colombo, Karlstein (DE)

Correspondence Address: DENNISON, SCHULTZ & MACDONALD, 1727 KING STREET, SUITE 105, ALEXANDRIA, VA, 22314, US

(73) Assignee: SCHNEIDER ELECTRIC AUTOMATION GMBH, Seligenstadt (DE)

(21) Appl. No.: 12/680,085

(22) PCT Filed: Oct. 2, 2008
(86) PCT No.: PCT/EP08/63219

§ 371 Date: May 11, 2010

(30) Foreign Application Priority Data
Oct. 5, 2007 (DE) 10 2007 048 050.6

(51) Int. Cl. G06F 9/46; G06F 9/00; G06F 15/173

(52) U.S. Cl. 713/1; 719/320; 709/223

(57) ABSTRACT

An automation device with an execution mechanism for control programs and also a web-services stack for communication with other automation devices and/or automation software, as well as a method for programming thereof are disclosed. For programming and configuration of the control program, the invention provides that the automation device has an integrated, web-based programming interface. According to the method, a connection is set up between the web browser and a web-based programming interface integrated in the automation device, a programmer/configuration application is displayed in the web browser, at least one control program is generated by use of a programming language, and a web service is configured for access to the at least one control program.

The invention relates to an automation device with a control program according to the preamble of claim 1 as well as to a method for the programming and/or configuration of at least one control program of an automation apparatus according to the preamble of claim 8.

An automation apparatus with Web Service Stack as well as a method for running an automation program in an automation apparatus is described in WO 2008/101912 A1. Here, it is provided for the remote controlled running of the automation program to be at a higher level than the automation program as well as the Web Service Stack. The automation apparatus can be connected via a network to other automation apparatuses and/or applications, where the Web Service Interface can be recognized over the network by means of a protocol, such as, WS Discovery for higher level software applications, and where subscriptions to version updates are available.

The programming, modification, configuration and/or debugging of the automation program is not discussed in WO 2008/101912 A1.

In an article by F. Jammes; A. Mensch; H. Smit: “Service-oriented device communications using the device profile for web services,” MPAC '05, Nov. 28-Dec. 2, 2005, Grenoble, France, the advantages of introducing service oriented architectures at the level of the communication between resource-dependent embedded apparatuses are described. The discussion relates particularly to the use of the so-called “Device Profile for Web Services” (DPWS) as a basis for such architectures for “intelligent” apparatuses.

In this article—as well as below—the term “Service-oriented architecture” (SOA) denotes an architecture as a set of architectural principles for the set up of autonomous and dialog capable or completely compatible systems. Here, “autonomous systems” means that the systems are formed independently of each other, operated independently of their environment, and present an inherent functionality, for example, this functionality can be helpful even if it is not connected with a functionality of higher level.

The dialog capacity or complete compatibility is promoted by a clear abstraction of the interface or of the communication interface, which presents a service to its environment by the implementation of the service.

Fundamental interaction patterns of an apparatus level SOA can be described using five function levels: addressing, discovering, describing, control, and event. Here the apparatuses are characterized either as controlling or controlled apparatuses; however, a given apparatus can incorporate both roles, allowing “peer-to-peer” interactions. Furthermore, descriptions are provided of apparatus-level service-oriented protocols, such as, for example, UPnP (Universal Plug and Play) including IP, TCP, UDP, HTTP, SOAP and XML.

The discussion regarding the “Device Profile for Web Services (DPWS)” is also described in detail, where the latter presents the same advantages as UPnP, while additionally being completely oriented toward Web Service Technologies.

The DPWS specifications define an architecture in which apparatuses presented two types of services: “hosting services” and “hosted services.” “Hosting services” play an essential role in the apparatus discovery process. “Hosted services” are usually functionally dependent on their “hosting” apparatus for the discovery. In addition to the “hosted services,” DPWS specifies a set of incorporated services:

“Discovery Services:” used by an apparatus that is connected to a network, to identify themselves, and to discover other apparatuses.

“Meta Data Exchange Services:” establishes a dynamic connection with the “hosted service” of the apparatus and to its meta data, such as, for example, WSDL and XML schema definitions.

“Published Subscribe Eventing Services:” allows apparatuses to subscribe to asynchronous event messages produced or generated by an appropriate service.

In conventional DPWS terminology use, a “controlled” apparatus is simply called “apparatus,” while a “controlling” apparatus is referred to as “client.”

A DPWS protocol stack consists of the following components:

“WSDL” (Web Services Description Language) for the abstract definition of service communication interfaces (interfaces) and their connection with transmission/transport protocols.

“XML schema” for the definition of the data formats which are used for the set up of the messages that are addressed to services and received by services

“SOAP,” the protocol for the transport of service-related communications that are formatted in agreement with their corresponding WSDL definitions

“WS addressing” is closely linked with the SOAP, and concentrates all the addressing information in the header of the SOAP message envelope, which makes it possible to transmit the message content via any transport protocol (HTTP, SMTP, TCP, UDP, . . . )

“WS policy” is used to express rules in connection with the Web Service in the form of “policy assertions” which complete the WSDL description of the service

“WS metadata exchange” allows the dynamic querying of metadata which are associated with the Web Service (description, schema and policy); thus it makes available the Web Service self testing mechanism

“WS security” is an optional set of mechanisms to ensure “end-to-end” message integrity, confidentiality and authenticity.

The DPWS Protocol Stack integrates all the above represented standards. In addition to the above described Web Service core protocols, DPWS Web Service protocols complete the “discovery” and “preventing.” For example,

“WS discovery” is a protocol. for “plug-and-play” discovery of network connected resources. It defines a multicast protocol for searching for and discovering apparatuses. Once discovered, the apparatus displays the services that it provides.

“WS eventing” defines a protocol that processes a “publish-subscribe” event, allowing a Web Service to exchange event related messages with other Web Services. WS eventing is provided for the implementation of a number of applications, from apparatus-oriented to “enterprise scaled published subscribed” systems, in the upper portion of their architecture.

Typically each DPWS based service has a certain WSDL description. This description is apparatus specific, and thus different apparatus types have different WSDL descriptions with little commonality.

In various functions, the code of the DPWS needs to process communications. These functions are dependent on the DPWS description of a certain service. To allow one service to communicate with another one in this connection, both services must implement the appropriate specific functions of the other. Therefore, each WDSL description must be compiled each time a new service is formulated, to generate a server code and a client code.

If the services that abstract the apparatuses communicate with each other in a dynamic environment with a large number of apparatuses, then it becomes impractical for a certain service to implement all the users, on the basis of the communications that it exchanges with others. This is particularly critical when the apparatuses are exposed to a large number of processes/runs.

In addition, in network environments, in which it is desirable to have a collection of apparatuses, reprogramming is a difficult obstacle for the dynamic change of the collection of apparatuses as well as for the immediate operational connectivity of the system.

The paper by F. Jammes et al.: “Orchestration of Service-Oriented Manufacturing Process,” at IEEE, 2005, describes the use of the service oriented architecture in the networking of industrial automation apparatuses. The automation apparatuses comprise Web Services which are provided with common, universal access interfaces, to allow automatic recognition and a start of functions which make the automation apparatus operationally ready.

Neither the running of automation programs nor the programming/configuring and processing of the automation programs is described in the paper.

Thus, the present invention is based on the problem of modifying an automation apparatus and a method for the programming of control programs of the automation apparatus in such a way that it is possible in a simple way to prepare, modify as well as debug the control program.

The problem is solved according to the invention by an automation apparatus, where the automation apparatus presents an integrated web-based programming interface.

The programming interface is arranged preferably in an embedded web server and accessible through a web browser that is connected to the automation apparatus. For this purpose, the automation apparatus is connected preferably via a bus system to additional automation apparatuses as well as to the web browser through which the programming face is accessible.

As a result, the following functions are made possible:

preparation of a new control program

modification of the code for a control program

starting, stopping, releasing, deactivating, resetting of control programs

configuration of the XML Web Service Interface for a control program:
message structure/schema
called control program
parameter transmission
event generation
service end point configuration: name and call address

debugging control programs.

It is preferred for the automation device to be programmable and/or testable via the programming interface by means of an automation language, such as, IEC-61131LD, FDD, ST or IL.

Moreover, the automation apparatus is characterized in that the Web Services and XML messaging can be configured by means of the programming interface.

Moreover, it is provided for the control programs and/or control program tasks to be callable by XML messaging and/or Web Services, or for XML event messages to be generated if user defined process conditions are satisfied.

According to an additional preferred embodiment, the execution mechanisms for the control programs, the Web Service Stack as well as the programming interface are integrated in the same processes and preferably run on it. Here, the Web Service/XML messaging functions and the programming environment share the same embedded web server.

The Web Service functions as well as the XML messaging functions are connected via an interpreter, such as, IEC-61131, to the execution mechanism of the control programs.

Furthermore, the invention relates to a method for programming and/or configuring at least one control program of an automation apparatus, which is connected via a network with other automation apparatuses as well as with at least one web browser, and used for the communication with other automation apparatuses and automation software Web Services. The method according to the invention comprises the following process steps:

set up of a connection between the web browser and a web-based program interface integrated in the automation apparatus,

representation of a programming/configuration application in the web browser,

generation of at least one control program using an automation language, and

configuration of a web service for access to the at least one control program.

The programming interface preferably provides a programming environment which allows the programming of the automation apparatus by means of an automation language, such as, IEC-61131LD, FDB, ST or IL. In the process, the Web Services based XML messaging is configured via the automation language, and the control programs are debugged.

To generate XML event messages, it is preferred to use XML messaging and/or Web Services.

It has been found to be particularly advantageous for the execution mechanism for control programs, XML messaging and programming-debugging functions to be permanently integrated in the same processor and to run on it.

According to an additional preferred procedure, the Web Service/XML messaging functions and the programming environment share the same embedded web server, such as, HTTP server.

Here, the Web Service/XML messaging functions have direct software access to the execution mechanism for control programs, such as, for example, an IEC-61131 interpreter.

Additional details, advantages and characteristics of the invention can be obtained not only from the claims, and from the characteristics that can be obtained from the claims, alone and/or in combination, but also from the preferred embodiment examples that can be obtained from the following description of the drawing.

The figures show:

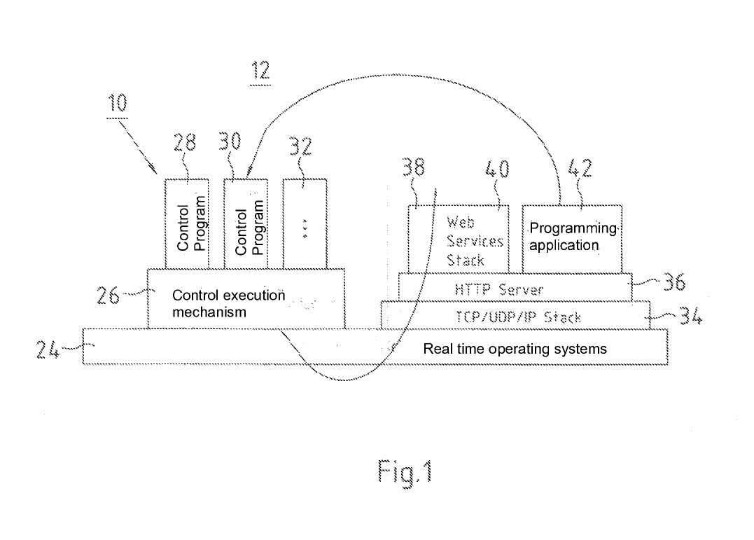

FIG. 1 a function diagram of an automation apparatus, and

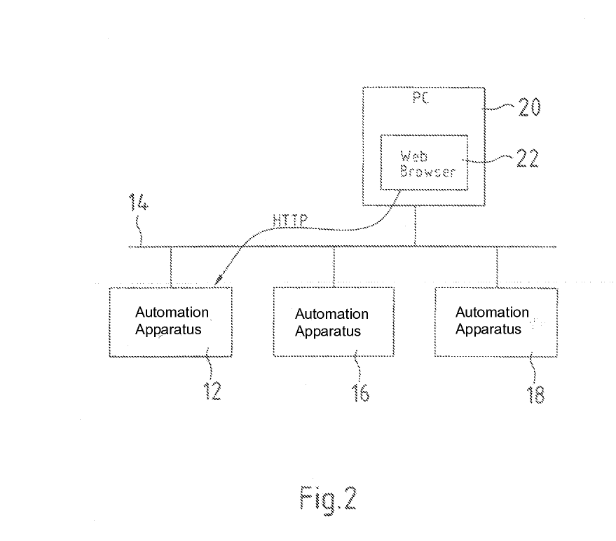

FIG. 2 a schematic representation of the access through a web browser to a program application integrated in the automation apparatuses.

FIG. 1 is a function diagram 10 of an automation apparatus 12, which is connected according to FIG. 2 via the network 14 with additional automation apparatuses 16, 18 as well as a personal computer 20 with integrated web browser 22.

Below, the function diagram 10 is explained in reference to examples of the automation apparatus 12. The latter comprises a real time operating system 24, in which a control execution mechanism 26 runs for the execution of control programs 28, 30, 32.

To connect the automation system 12 with the network 14, a TCP/UTB/IP stack 34 as well as an HTTP server 36 is provided. The TCP/UTB/IP stack 34 as well as the HTTP server 36 form transport layers for the transport of messages via the network 14. Above the transport layers 34, 36, a Web Services Stack 38 is arranged, which makes available Web Services 40 that can be used for the communication with other automation apparatuses 16, 18, and automation or control software.

According to the invention, the automation apparatus 12 presents an integrated web based programming interface 42, which makes available an embedded web based programming environment.

The programming interface 42 is located in the embedded Web Server 36 and accessible via the web browser 32 which is connected by the network 14 with the automation apparatus 12.

The programming environment made available by the programming interface 42 allows the programming of the automation apparatus 12 by means of a programming language, such as, for example, LD, FBD, ST or IL according to IEC-61131. Furthermore, the Web Services 40 and XML messages contained in the Web Services Stack 38 can be configured, and the control programs 28, 30, 32 can be debugged.

In addition, XML messaging and/or Web Services 40 are used to call the control programs/tasks 28, 30, 32 or to generate XML event messages, when the user defined process conditions have been met.

The control execution mechanism 26, the Web Services Stack 38 with XML messaging and the programming/debugging functions of the programming interfaces 42 are permanently integrated within the automation apparatus, and they run on the same processor in the real time operating system 24.

The Web Service/XML messaging functions and the programming environment made available by the programming interface 42 share the same embedded Web Server 36 for their communication with the network 14. Both functions have direct access to the control execution mechanism 26, which can be configured, for example, as an IEC-61131 interpreter.

FIG. 1 shows the function diagram of the automation apparatus 12. The automation apparatus is provided with a control execution mechanism 26 for the control programs 28, 30, 32. The Web Services Stack 38 allows:

calling the execution of control programs 28, 30, 32: an XML message received by the stack 38 calls a function in the execution mechanism 26 to start a given control program 28, 30, 32, as well as an IEC-61131-3 task, where parameters extracted from the XML message are used.

generating event messages: during the execution of the control program 28, 30, 32, one or more event messages can be generated, which are reported and distributed through the Web Services Stack 38 as XML messages.

In addition, the programming application or the programming interface 42 is accessible through the web server 36 via the web browser 22 represented in FIG. 2, and it allows functions, such as:

preparation of a new control program

modification of the code for a control program

starting, stopping, releasing, deactivating, resetting of control programs

configuration of the XML Web Service Interface for a control program:
message structure/schema
called control program
parameter transmission
event generation
service end point configuration: name and call address

debugging control programs.

Below, the configuration steps of a service oriented automation apparatus are described.

A control technician sets up a connection using the web browser 22 with the automation apparatus 12. The home page represented by the apparatus allows access to the programming interface 42; for this purpose, it is possible to require the mentioning of user name and password, to authenticate the technician.

The programming and configuration application 42 is then represented in the web browser 22. The application can be implemented as JavaApplet, JavaScript, .NET program or AJAX style application.

The technician then uses the application 42 to generate several control programs 28, 30, 32, where an IEC-61131 language is used. The programming application 42 internally translates the 61131 code into a native byte code or an interpreted byte code.

Then, the technician configures a Web Service 38, 40 which can be used to access one of the control programs 28, 30, 32. The configuration consists in defining a call message, the mapping of message parameters to control program parameters, and the addition of any event messages that are produced.

The technician can then continue debugging the application via the web browser 22, or use appropriate commands to allow the independent execution of the program.

In summary, it is noted that an automation apparatus is made available which provides an integrated web-based programming interface and which uses Web Services for the communication with other automation apparatuses and automation software. The programming interface is located in an embedded web server, and it is accessible via a web browser which is connected to the automation apparatus.

The programming environment allows the programming of the automation apparatus by means of an automation language, such as, for example, LD, FBD, ST or IL according to IEC-61131, which configures the Web Services and XML messaging, and debugs the control programs.

1-17. (canceled)

18. Web Service based Automation device (12, 16, 18) with an execution mechanism (26) for control programs (28, 30, 32) as well as for a Web Services Stack (38) for communication with other automation apparatuses (12, 16, 18) and/or automation software via Web Services, characterized in that the automation apparatus (12, 16, 18) presents an integrated web-based programming interface (42) which is arranged in an embedded web server (36), that the Web Service functions as well as the XML Messaging functions (40) and the programming interface (42) use the same embedded web server (36) and are coupled via an interpreter with the execution mechanism (26) for control programs (28, 30, 32).

19. Web Service based automation apparatus according to claim 18, wherein the automation apparatus (12, 16, 18) is connected via a network (14) with additional automation apparatuses (12, 16, 18) as well as with a web browser (20) through which the programming interface (42) is accessible.

20. Web Service based automation apparatus according to claim 18, wherein the automation apparatus (12, 16, 18) and/or the control programs (28, 30, 32) is programmable via the programming interface, with the programming by means of an automation language, such as, LD, FBD, ST or IL according to IEC-61131.

21. Web Service based automation apparatus according to claim 18, wherein the execution mechanism (26) for the control programs (28, 30, 32), the Web Services Stack (38) as well as the programming interface (42) is integrated in the same processor and runs on it.

22. Web Service based automation apparatus according to claim 18, wherein the Web Server (36) is an HTTP server.

21. Service based automation apparatus according to claim 18, wherein the interpreter is an IEC-61131 interpreter.

22. Method for the configuration of a Web Service based automation apparatus (12, 16, 18) which is connected via a network (14) with additional Web Service based automation apparatuses (12, 16, 18) as well as with at least one web browser (22), and used for communication with other automation apparatuses and automation software Web Services (40),
wherein the method uses programming of at least one control program (28, 30, 32) of a Web Service based automation apparatus (12, 16, 18) via the web browser (22), which comprises the steps of:
set up of a connection between the web browser (22) and a web-based programming interface (42) integrated in the automation apparatus (12, 16, 18),
representation of a programming/configuration application in the web browser (22),
generation of at least one control program (28, 30, 32) using a programming language, and
configuration of a Web Service (40) for the access to the at least one control program (28, 30, 32) by the definition of Web Service/XML messaging functions which have direct software access to the execution mechanisms for control programs.

23. Method according to claim 22, wherein the programming interface (42) produces a programming environment, which allows the programming of the automation apparatus by means of a programming language, such as, LD, FBD, ST or IL according to IEC-61131.

24. Method according to claim 22, wherein the Web Services (40) and their XML messaging are configured via the programming language, and the control programs (28, 30, 32) are debugged.

25. Method according to claim 22, wherein XML messaging and/or Web Services are used for calling the control programs (28, 30, 32) and/or control program tasks.

26. Method according to claim 22, wherein XML messaging and/or Web Services are used for the generation of XML event messages.

27. Method according to claim 22, wherein the execution mechanism (26) for control programs (28, 30, 32), XML messaging and programming/debugging functions are permanently integrated in the same processor, and run on it.

28. Method according to claim 22, wherein the Web Service/XML messaging functions and the programming environment use the same embedded web server as HTTP server.

29. Method according to claim 22, wherein the Web Services Stack (38) makes it possible to call the execution of the at least one control program (28, 30, 32), where it is preferred to use an XML message received by the Web Services Stack (38) to call a function in the execution mechanism (26) for control programs (28, 30, 32) to start a given control program, where parameters extracted from the XML message are used.

30. Method according to claim 22, wherein during the execution of the at least one control program (28, 30, 32), the Web Services Stack (38) generates one or more event messages which are announced and distributed as XML message through the Web Service Stack.
